(19) United States
(12) Patent Application Publication
(10) Pub. No.: US 2015/0170306 A1
(43) Pub. Date: Jun. 18, 2015

(54) System and Method for Tracking and Monitoring Medical Diversion

(71) Applicant: Isiah Harper, Boonsboro, MD (US)

(72) Inventor: Isiah Harper, Boonsboro, MD (US)

(21) Appl. No.: 14/574,378

(22) Filed: Dec. 17, 2014

Related U.S. Application Data
(60) Provisional application No. 61/916,892, filed on Dec. 17, 2013.

(51) Int. Cl. G06Q 50/22; G06Q 30/00

(52) U.S. Cl. CPC G06Q 50/22; G06Q 30/018

(57) ABSTRACT

A system for monitoring and tracking the diversion of drugs and medical equipment. The system comprises a database that is accessible by any medical institutions connected thereto and system for reporting drug or medical equipment diversion events and then forwarding those reports to the appropriate individuals to investigate. If the investigation confirms that the diversion event occurred, then the system uploads the report to the database so that all medical institutions connected thereto can access it, alerts the relevant authorities, and provides a recommendation to the user as to the next course of action that the user should take. The recommendation may be based upon a number of factors, including the type of item that was diverted and the diversion history of the diverter. The system thereby provides connected institutions with alerts to prevent further diversions by the diverter, but also seeks to encourage treatment for the diverter.

### CROSS REFERENCE TO RELATED APPLICATION

This application claims the benefit of U.S. Provisional Application No. 61/916,892 filed on Dec. 17, 2013. The above identified patent application is herein incorporated by reference in its entirety to provide continuity of disclosure.

### FIELD OF THE INVENTION

The present invention relates to computer systems and methods for tracking medical equipment and drugs. More specifically, the present invention relates to computer systems and methods for tracking and monitoring individuals that are diverting medical equipment and drugs.

### BACKGROUND OF THE INVENTION

Medical institutions lack the ability to quickly and efficiently communicate amongst themselves and alert each other of diversion events. This means that it can be very difficult to catch and ultimately prevent individuals from diverting medical equipment and drugs because they can bounce from medical institution to medical institution, diverting drugs until they are caught without any warning to the new medical institution. The diversion of drugs and medical equipment is a major cost for medical institutions, therefore there is a need in the prior art for a centralized system for tracking individuals who are diverting medical equipment and drugs.

### SUMMARY OF THE INVENTION

In view of the foregoing disadvantages inherent in the known types of drug and medical equipment tracking systems and methods now present in the prior art, the present invention provides a system and method for tracking and monitoring the diversion of drugs and medical equipment wherein the same can be utilized for providing convenience for the user when seeking to provide a centralized means for medical institutions to quickly and efficiently communicate amongst themselves and alert each other as to drug diversion events. The present invention comprises a database that is accessible by any medical institutions connected thereto and system for reporting drug or medical equipment diversion events and then forwarding those reports to the appropriate individuals to investigate. If the investigation confirms that the diversion event occurred, then the system uploads the report to the database so that all medical institutions connected thereto can access it, alerts the relevant authorities, and provides a recommendation to the user as to the next course of action that the user should take. The recommendation may be based upon a number of factors, including the type of item that was diverted and the diversion history of the diverter. The system thereby provides connected institutions with alerts to prevent further diversions by the diverter, but also seeks to encourage treatment for the diverter.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a diagram of the computer system of the present invention.

FIG. 2 shows a method of operation of the present invention.

### DETAILED DESCRIPTION OF THE INVENTION

Reference is made herein to the attached drawings. Like reference numerals are used throughout the drawings to depict like or similar elements of the system and method for tracking and monitoring the diversion of drugs and medical equipment. For the purposes of presenting a brief and clear description of the present invention, the preferred embodiment will be discussed as used for tracking drug diversion events, alerting medical institutions as to the diversion event, and preventing further diversion by the diverter. The figures are intended for representative purposes only and should not be considered to be limiting in any respect.

As used herein, “logic” refers to (i) logic implemented as computer instructions and/or data within one or more computer processes and/or (ii) logic implemented in electronic circuitry. As used herein, “computer-readable medium” excludes any transitory signals, but includes any non-transitory data storage circuitry, e.g., buffers, cache, and queues, within transceivers of transitory signals. As used herein, “diversion event” refers to the theft, unauthorized taking, or obtaining under false pretenses of medical equipment or drugs by patients or medical personnel, such as doctors and nurses, for non-medical reasons.

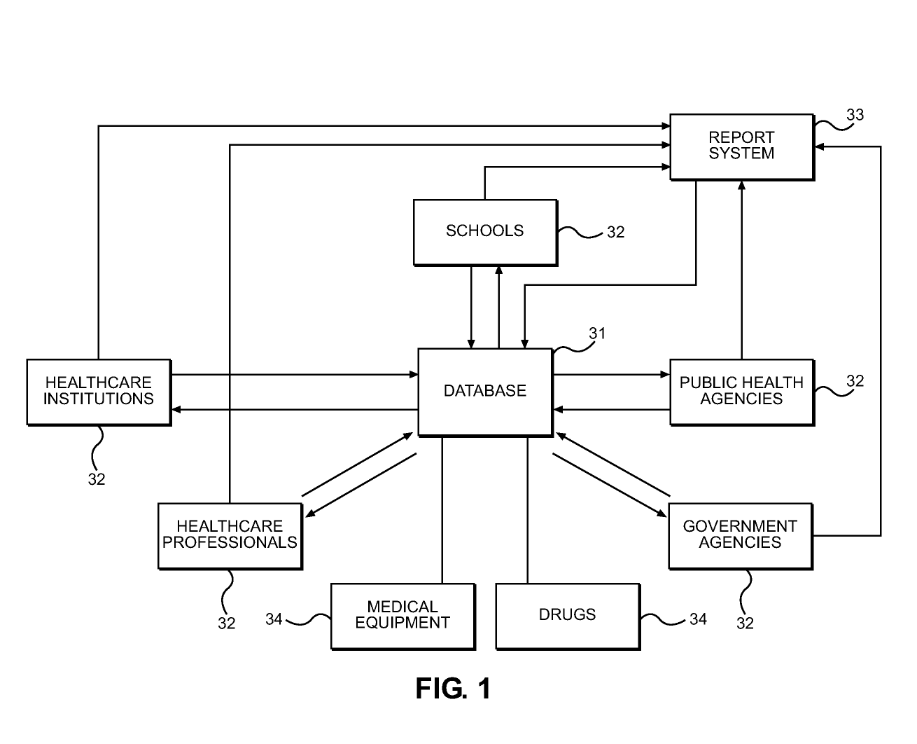

Referring now to FIG. 1, there is shown a diagram of the computer system of the present invention. The present invention comprises a database 31 and a report system 33 that are accessible via a plurality institutions 32, such as hospitals, healthcare institutions, healthcare professionals, government agencies, public health agencies, schools, and any other such institution that makes use of medical equipment or drugs or that would have an interest in being made aware of individuals that have a history of diverting drugs or medical equipment. The database 31 comprises a listing of all types of tracked items 34, such as medical equipment and drugs, and reports of drug and medical equipment diversion events that are transmitted to it by the report system 33. The institutions 32 are able to access the database 31 to retrieve the diversion reports, statistics on the number of diversion events associated with each type of medical equipment or drug, the number of diversion events that occur at each institution 31 connected to the system, and other such information. Furthermore, institutions 32 can query the database 31 to obtain a listing of all of the diversion events associated with an individual. Participating institutions 32 can therefore check to see whether an individual has a history of diverting drugs or medical equipment prior to providing the individual with access to equipment or drugs that is at risk of being diverted, prescribing a medication that can be abused for recreational purposes to the individual, or other such activity.

Institutions 31 are able to generate reports of diversion events by accessing the report system 33 of the present invention. The report system 33 is adapted to receive reports of diversion events that are transmitted to the report system 33 from personnel of the participating institutions. If the report system 33 then receives verification that the reported diversion event did in fact occur, then then report system 33 transmits the report to the database 31 for categorization and storage thereon. The uploaded report can thereafter be retrieved by participating institutions 31. The present system thereby provides participating institutions 31 with a centralized system for communicating the occurrence of a diversion event, the identity of the diverter, the piece of equipment and/or drug that was diverted, and other such data.

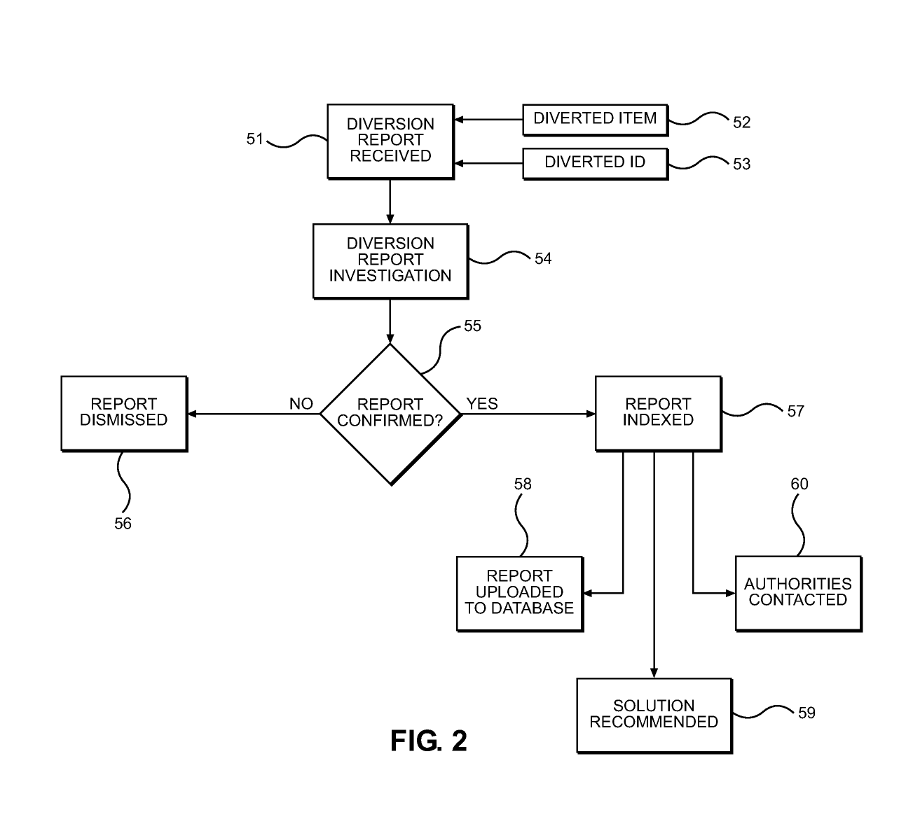

Referring now to FIG. 2, there is shown a method of operation of the present invention. The present system and method first receives 51 an incident report of a diversion event that is generated by a member of a participating institution and uploaded to the report system. The report of the diversion event contains at least a diverted item ID 52 and a diverter ID. The diverted item ID 52 comprises a name of the piece of equipment of drug, a product description, an internal ID tag for the institution, a product order code, a unique ID for the product assigned by the database of the present system, or any other such means for identifying the diverted item. The diverter ID comprises the name of the diverter, an employee number (if the diverter is an employee of the institution), a social security number, or any other such means for identifying the individual that diverted the piece of medical equipment or drug. The diversion report may further include other information associated with the diversion event, such as the date of the occurrence, the institution from which the item was diverted, observations of the diverters behavior prior to and after the incident, or any other notes of the individual generating the diversion report.

Once the diversion report is received 51 by the present system, it is then transmitted to an assigned individual or body of individuals for overview and investigation 54. The individuals to which the diversion report is transmitted include a supervisor of the individual who uploaded the diversion report to the present system at the institution itself, an independent oversight body that investigates diversion reports generated by participating institutions, or other such individuals. During the investigation 54, the diversion report is quarantined from the database that is freely accessible by all participating institutions and viewable solely by a select number of individuals, including the individuals investigating 54 the diversion report. This is to ensure that unverified diversion reports do not compromise innocent individuals.

After the diversion report is investigated 54 by the assigned individuals, said individuals then either confirm or deny 55 the diversion report. If the diversion report is not confirmed, then it is dismissed 56 and deleted from the present system. If the diversion report is confirmed, then the report is cataloged 57 by the present system. A cataloged report 57 is uploaded to the database 58 that is freely accessible by the member institutions. When uploaded to the database 58, the diversion report is cataloged according to the data associated therewith so that member institutions can directly retrieve the report by querying the database and so that it is also incorporated into statistics tracked by the present system, which can then in turn be queried by member institutions. The personnel of member institutions can query the database to obtain statistics based upon a large number of variables that may be associated with the diversion reports, such as the time period during which the diversion period took place, the institution at which the diversion event occurred, the gender of the diverter, or the prevalence of diversion events for various categories of items.

Furthermore, as each diversion report is tagged with a user ID, the personnel of the member institutions can query a user ID, e.g. a name, and obtain a comprehensive list of all of the diversion events associated with that user ID. The individuals performing the query can then take the necessary actions, including denying the individual a prescription or preventing the individual from obtaining access to medical equipment or drugs that could potentially be diverted.

In an alternative embodiment of the present system, the database contains a list of user IDs associated with all of the personnel of the participating institutions. When a report is uploaded 58 to the database, the present system automatically queries the list of user IDs contained within the database to search for a match with the user ID associated with the report. If the present system matches the user ID to a pre-existing user ID within the database and that pre-existing user ID is an employee of a participating institution, then the access privileges of the employee associated with that user ID are automatically revoked. The revoked access privileges include access to the present system so that the individual cannot access or otherwise alter the diversion report associated with them and access to the internal systems of the institution. With the diverter's access revoked from the institution's internal systems, the employee is prevented from further diverting drugs or medical equipment.

In addition to cataloging 57 and uploading 58 the diversion report to the database, an alternative embodiment of the present invention further contacts the authorities 60. In this embodiment, the present system may automatically generate a police report that is then transmitted to the police, upload an incident report to a government incident tracking system, or take other such measures to notify local or federal authorities as to the occurrence of the diversion event. Furthermore, the present system may be programmed to contact different local or government authorities based upon the ID of the diverted item. For example, the theft of a common medical equipment item may simply be reported to the local police, whereas the theft of a Schedule I drug may be reported to the DEA or another such federal agency.

Furthermore, the intent of the present system is to encourage the treatment of individuals who are diverting drugs or medical equipment because many such individuals are performing these tasks to fulfill an addiction. Therefore, those who are abusing drugs for recreational purposes and other such individuals need the assistance of the personnel to curb their addiction. The present system encourages individuals to take a proactive, solution-focused approach to problems by suggesting solutions 59 to personnel of member institutions querying a user ID to obtain a history of the user ID's diversion events, individuals generating diversion reports, and/or individuals investigating diversion reports to determined their validity. The recommended solutions may be based upon the history of diversion events associated with the user ID, age, gender, the types of items diverted, and other such variables. These recommended solutions 59 may be pre-programmed into the present system, uploaded by participating institutions based upon said institutions' experiences with different types of drug or medical equipment diverters, or uploaded to the present system by an oversight board that is composed of medical personnel.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A computer system, comprising:
one or more processors;
a non-transitory computer readable medium operatively connected to the one or more processors;
a database;
a logic stored in the non-transitory computer readable medium that, when executed by the one or more processors, causes the computer track and monitor diversion of medical equipment or drugs, by at least:
receiving a diversion report comprising a diverter ID and a diverted item ID;
transmitting the diversion report to an overseer for review;
receiving an investigation decision;
if the investigation decision does not confirm the diversion report, then dismissing the diversion report;
if the investigation decision confirms the diversion report, then uploading the diversion report to the database, contacting one or more authorities, and providing a recommendation.

2) The computer system of claim 1, wherein the recommendation is based upon the diverted item ID and a diversion history of the diverter ID.

3) The computer system of claim 1, further comprising the steps of:
searching the database for the diverter ID;
if the diverter ID matches a user ID stored thereon, revoking access to the computer system for the user ID.

4) The computer system of claim 3, further comprising the steps of:
if the diverter ID matches the user ID, revoking access to an equipment checkout system for the user ID.

5) The computer system of claim 3, further comprising the steps of:
if the diverter ID matches the user ID, revoking access to a drug checkout system for the user ID.

6) A non-transitory computer readable medium that, when executed by one or more processors, causes said one or more processors to perform a method comprising the steps of:
receiving a diversion report comprising a diverter ID and a diverted item ID;
transmitting the diversion report to an overseer for review;
receiving an investigation decision;
if the investigation decision does not confirm the diversion report, then dismissing the diversion report;
if the investigation decision confirms the diversion report, then uploading the diversion report to the database, contacting one or more authorities, and providing a recommendation.

7) The non-transitory computer readable medium of claim 6, wherein the recommendation is based upon the diverted item ID and a diversion history of the diverter ID.

8) The non-transitory computer readable medium of claim 6, further comprising the steps of:
searching a database for the diverter ID;
if the diverter ID matches a user ID stored thereon, revoking access to the database for the user ID.

9) The non-transitory computer readable medium of claim 8, further comprising the steps of:
if the diverter ID matches the user ID, revoking access to an equipment checkout system for the user ID.

10) The non-transitory computer readable medium of claim 8, further comprising the steps of:
if the diverter ID matches the user ID, revoking access to a drug checkout system for the user ID.

11) A computer-implemented method, comprising the steps of:
receiving a diversion report comprising a diverter ID and a diverted item ID;
transmitting the diversion report to an overseer for review;
receiving an investigation decision;
if the investigation decision does not confirm the diversion report, then dismissing the diversion report;
if the investigation decision confirms the diversion report, then uploading the diversion report to the database, contacting one or more authorities, and providing a recommendation.

12) The computer-implemented method of claim 11, wherein the recommendation is based upon the diverted item ID and a diversion history of the diverter ID.

13) The computer-implemented method of claim 11, further comprising the steps of:
searching a database for the diverter ID;
if the diverter ID matches a user ID stored thereon, revoking access to the database for the user ID.

14) The non-transitory computer readable medium of claim 13, further comprising the steps of:
if the diverter ID matches the user ID, revoking access to an equipment checkout system for the user ID.

15) The non-transitory computer readable medium of claim 13, further comprising the steps of:
if the diverter ID matches the user ID, revoking access to a drug checkout system for the user ID.
